(19) United States
(12) Patent Application Publication
(10) Pub. No.: US 2026/0254699 A1
(43) Pub. Date: Aug. 27, 2026

(54) DYNAMIC UTILIZATION OF UPLINK CONFIGURATIONS

(71) Applicant: T-MOBILE INNOVATIONS LLC, Overland Park, KS (US)

(72) Inventor: Timur KOCHIEV, Irvine, CA (US)

(21) Appl. No.: 19/064,077

(22) Filed: Feb. 26, 2025

(51) Int. Cl. H04L 27/26; H04B 7/06; H04B 17/318; H04W 72/21

(52) U.S. Cl. CPC H04L 27/2656; H04B 7/0617; H04B 17/328; H04W 72/21

(57) ABSTRACT

A method for dynamically utilizing one or more frequency division duplex (FDD) and time division duplex (TDD) carriers for uplink are provided. The method includes determining, based on a first performance of a user equipment (UE) falling below a pre-determined threshold, whether to instruct the UE to utilize a different uplink configuration. The method includes instructing, based on the determining, the UE to utilize a first uplink configuration comprising utilizing TDD carrier for a first layer and utilizing a FDD carrier for a second layer. The method includes determining, based on a second performance of the UE, to instruct the UE to cease utilizing the first uplink configuration. The method includes instructing the UE to utilize a second uplink configuration comprising utilizing one or more TDD carriers for the first layer and the second layer.

### SUMMARY

The present disclosure is directed, in part to systems and methods of dynamically utilizing one or more time division duplex (TDD) carriers and/or one or more frequency division duplex (FDD) carriers, substantially as shown and/or described in connection with at least one of the figures, and as set forth more completely in the claims.

Systems and methods for dynamically utilizing different uplink configurations based on real time data and/or historical data are provided. A network node may determine whether to instruct a particular user equipment (UE) to utilize a different uplink configuration, based on, for example, the real time performance of the UE, historical data associated with the UE or the network, and whether the UE is within a threshold distance of a cell edge. Based on at least some of these determinations, the network node may instruct the UE to utilize a first uplink configuration. This determination may be repeated and may be changed over time such that a particular UE may switch between different uplink configurations based on the historical data and/or the real time data. Such systems and methods provide a dynamic approach that enables UEs to utilize the most effective uplink configuration at any particular time, enhancing UE performance overall.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary call flow for an exemplary method for dynamically utilizing one or more time division duplex (TDD) and frequency division duplex (FDD) carriers for uplink in which implementations of the present disclosure may be employed;

FIG. 4 illustrates a flow diagram of an exemplary method for dynamically utilizing one or more TDD and FDD carriers for uplink in which implementations of the present disclosure may be employed;

FIG. 5 illustrates a flow diagram of an exemplary method for dynamically utilizing one or more TDD and FDD carriers for uplink in which implementations of the present disclosure may be employed; and

FIG. 6 illustrates a flow diagram of an exemplary call flow for an exemplary method for dynamically utilizing one or more TDD and FDD carriers for uplink in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, user equipments (UEs), such as cell phones and network routers, may utilize various uplink configurations to communicate with the network. Some UEs may have be compatible with multiple-input multiple-output (MIMO) technology, which uses multiple antennas at both the transmitter (a UE) and receiver (a network node), enabling UEs to transmit and/or receive multiple streams of data simultaneously across different layers (e.g., different spatial paths of each data stream), effectively increasing data rates and reliability for customers having compatible UEs. MIMO is often utilized as a two layer (2L) time division duplex (TDD) MIMO, which may be referred to herein as 2L TDD, where a first layer utilizes a first TDD carrier and a second layer utilizes a second TDD carrier. However, the ability to effectively utilize such improved MIMO uplink configurations may be hindered based on a UE’s location within a coverage area, for example. For example, a UE compatible with MIMO may be prevented from utilizing conventional 2L TDD due to being located within a far cell and/or near a cell edge, where the performance of TDD carriers typically degrades. Systems and methods to optimize the utilization of MIMO compatible UEs are valuable.

Conventionally, UEs compatible with MIMO typically employ 2L TDD for uplink, as TDD carriers generally provide more bandwidth than frequency division duplex (FDD) carriers. However, TDD carriers typically do not propagate as far as FDD carriers. Thus, the conventional 2L TDD uplink configurations may provide performance improvements for UEs within a near cell, while the performance of 2L TDD uplink configurations degrades for UEs at a border of the near cell, within the far cell, or near the cell edge. In these UEs at the border of the near cell, at the far cell, and/or near the cell edge, mobile network operators conventionally determine to disable 2L TDD uplink configurations in favor of a single layer (1L) using a single TDD carrier for uplink, which may be referred to herein as 1L TDD. As a result, the benefits of MIMO uplink configurations are limited in these areas, as only one layer is being utilized in these UEs.

In contrast to conventional solutions and to provide a dynamic approach to utilizing MIMO, the present disclosure is directed to systems and methods for dynamically utilizing different uplink configurations based on real time data and/or historical data. A network node may periodically determine whether a particular UE should utilize 2L TDD, 1L TDD, or an uplink configuration comprising utilizing a TDD carrier for a first layer (1L) and a FDD carrier for a second layer (1L), which may be referred to herein as 1L TDD + 1L FDD uplink (UL) carrier aggregation (CA), based on, for example, the real time performance of the UE, historical data, and/or whether the UE is within a threshold distance of a cell edge. Based on these determinations, the network node may instruct the UE to utilize the 1L TDD + 1L FDD UL CA uplink configuration or the network node may instruct the UE to utilize one or more TDD carriers for uplink (i.e., 1L TDD or 2L TDD). This determination may change over time such that a particular UE may switch between utilizing 2L TDD, 1L TDD, and 1L TDD + 1L FDD UL CA. Such systems and methods provide a dynamic approach that enables UEs to utilize the most effective uplink configuration at any particular time, enhancing UE performance overall and enabling the effective utilization of network resources.

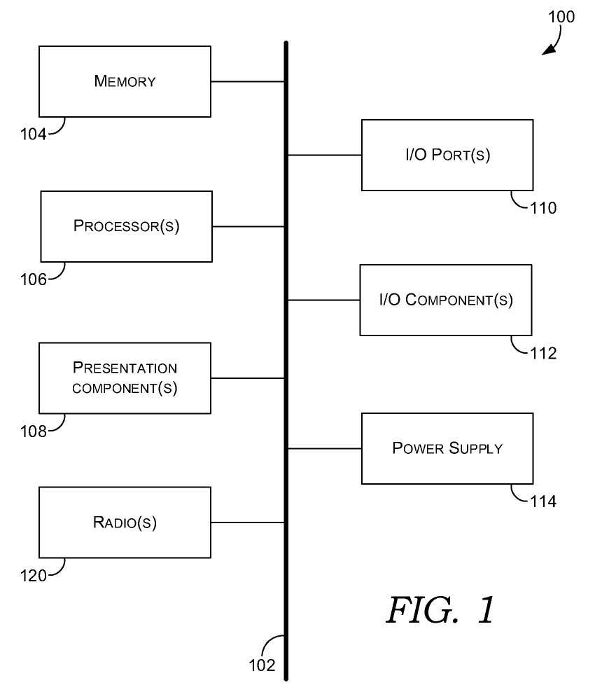

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, one or more input/output (I/O) ports 110, one or more I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of the one or more I/O components 112. Also, processors, such as the one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as the bus 102, the memory 104 or the one or more I/O components 112. The one or more presentation components 108 presents data indications to a person or other device. Exemplary one or more presentation components 108 include a display device, speaker, printing component, vibrating component, etc. The one or more I/O ports 110 allow computing device 100 to be logically coupled to other devices including the one or more I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, the radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

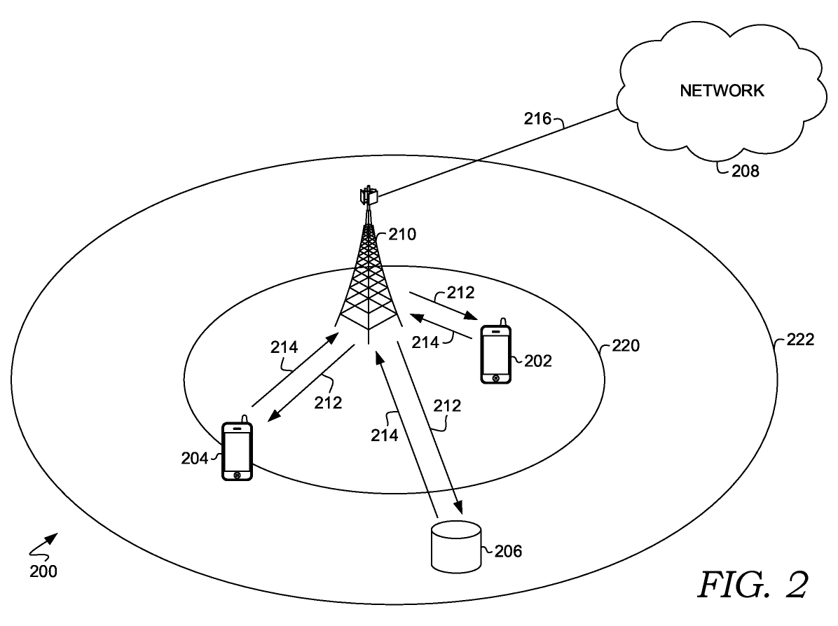

Network environment 200 represents a high level and simplified view of relevant portions of one or more modern wireless telecommunication networks. At a high level, the network environment 200 may generally be said to comprise one or more UEs, such as a first UE 202, a second UE 204, and/or a third UE 206, one or more network nodes, such as a base station 210, and a network 208, though in some implementations, it may not be necessary for certain features to be present. Similarly, while some components are shown in the singular, it is expressly contemplated that there may be more than one of the components described. The network environment 200 may include a number of routers, switches, and the like. The network environment 200 is generally configured for wirelessly connecting the first UE 202, the second UE 204, and/or the third UE 206 to data or services that may be accessible on one or more application servers or other network functions, nodes, or servers not pictured in FIG. 2 so as to not obscure the focus on the present disclosure.

The network environment 200 comprises the first UE 202, the second UE 204, and/or the third UE 206. The first UE 202 and the second UE 204 are illustrated as mobile cell phones, while the third UE 206 is illustrated as a fixed wireless access (FWA) device. While illustrated as specific examples, the first UE 202, the second UE 204, and/or the third UE 206 may take any number of forms, including any device discussed with respect to FIG. 1 and may have any one or more components or features of the computing device 100 of FIG. 1. The first UE 202, the second UE 204, and/or the third UE 206 may communicate with one or more access networks, such as the base station 210, to access data and/or services via the network 208. In aspects, one or more of the first UE 202, the second UE 204, or the third UE 206 may be a part of a group of UEs, and may be grouped together based on one or more similarities (e.g., uplink configuration capabilities, location within the network environment 200, associated with subscribers who have purchased a premium subscription).

The network environment 200 comprises one or more network nodes, such as the base station 210, to which the first UE 202, the second UE 204, and/or the third UE 206 may potentially connect to (also referred to as ‘camping on,’ ‘attaching,’ in the industry). Though network environment 200 is illustrated with one base station 210, one skilled in the art will appreciate that more or fewer base stations may be present in any particular network environment. While the base station 210 is illustrated as the one or more network nodes of the network environment 200, it is expressly contemplated that the one or more network nodes may take other forms (e.g., a satellite). The base station 210 of the network environment 200 is generally configured to wirelessly communicate with various UEs, such as the first UE 202, the second UE 204, and/or the third UE 206.

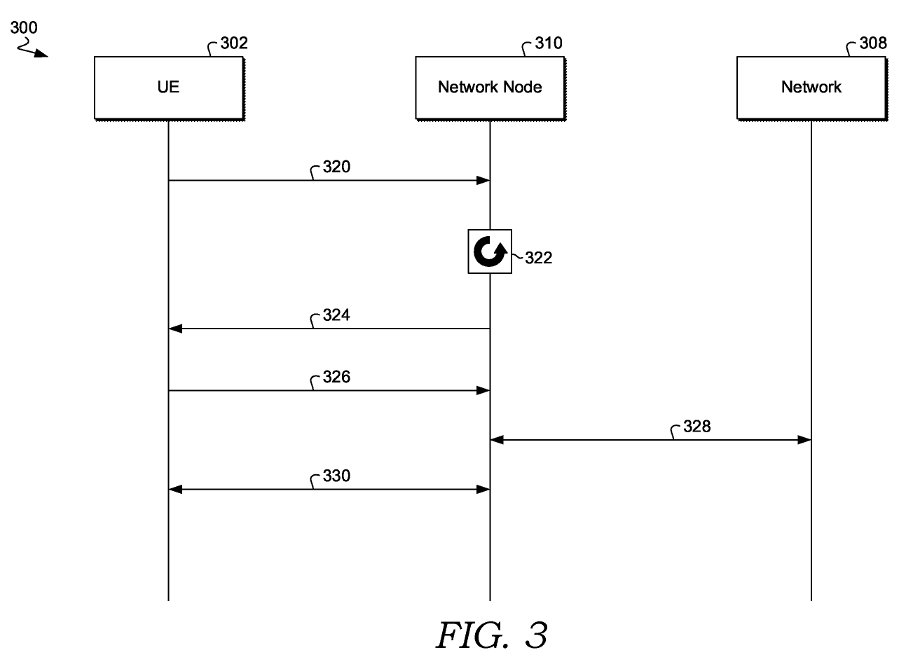

The base station 210 may communicate with the first UE 202, the second UE 204, and/or the third UE 206 using any wireless telecommunication protocol desired by a network operator, including but not limited to 2G, 3G, 4G, 5G, 6G, 802.11x, LoRa, LoRaWAN, and the like. The base station 210 may generally communicate signals to one or more UEs (e.g., the first UE 202, the second UE 204, and/or the third UE 206) via a downlink 212 and receive signals from one or more UEs via uplink 214. As will be described in more detail with respect to FIG. 3, the base station 210 may implement logic to determine an uplink configuration for a particular UE (e.g., the first UE 202, the second UE 204, and/or the third UE 206), such as whether to utilize a 2L TDD configuration or whether to utilize 1L TDD + 1L FDD UL CA uplink configuration. In response to receiving certain requests from the first UE 202, the second UE 204, and/or the third UE 206, for example, the base station 210 may communicate with the network 208 via a backhaul 216.

The base station 210 may comprise a near cell 220 and a far cell 222. The near cell 220 comprises a coverage area closest to the base station 210 and the far cell 222 comprises a coverage area extending from the near cell 220 and away from the base station 210 relative to the near cell 220. The first UE 202 is shown within the near cell 220 and may experience strong signal strengths and resulting high data speeds. The third UE 206 is shown within the far cell 222 and may experience reduced signal strength, reduced quality of service, and increased interference. The second UE 204 is shown at a border between the near cell 220 and the far cell 222, resulting in variable and inconsistent performance. In aspects, the base station 210 may determine the first UE 202, the second UE 204, and/or the third UE 206 require different uplink configurations based at least partially on their location within the network environment 200 relative to the base station 210.

The network 208 comprises any one or more public or private networks. The network 208 may be configured according to one or more network architectures and/or principles. In some aspects, the network 208 may comprise a cellular telecommunications network (e.g., a 2G, 3G, 4G, 5G, or 6G core network, an IMS network, and the like) and/or a data network (e.g., LAN, WAN, private enterprise network). For example, the network 208 may be a 5G network configured according to new radio (NR) protocols and/or specifications. In aspects, the first UE 202, the second UE 204, and/or the third UE 206 communicate with the network 208 via any one or more network nodes, such via the base station 210.

Turning now to FIG. 3, call flow diagram is illustrated in accordance with one or more aspects of the present disclosure and generally reflects systems and methods for dynamically utilizing one or more TDD and/or FDD carriers for uplink.

The call flow 300 may generally comprise a UE 302 (e.g., the first UE 202, the second UE 204, the third UE 206 of FIG. 2), a network node 310 (e.g., the base station 210 of FIG. 2), and a network 308 (e.g., the network 208 of FIG. 2). The call flow 300 is not meant to exhaustively show every interaction that would be necessary to practice the invention, so as not to obscure the present disclosure. One or more functions and/or components of the network 308 may perform at least some of the functions of the network node 310.

At a first step 320, the UE 302 communicates a message to the network node 310. In aspects, the communication from the UE 302 is an initial communication, such as an attach request. In other aspects, the communication to the network node 310 is a communication within an existing session with the network 308, such as to request data and/or services accessible via the network 308. The message may indicate a group identifier of the UE 302 indicating the UE 302 is a part of a group of UEs. In aspects, the message includes the uplink configuration capabilities of the UE 302, which may indicate the UE 302 is generally compatible with 2L uplink configurations (e.g., 2L TDD, 1L TDD + 1L FDD UL CA). The UE 302 may communicate the message via any one or more uplink configurations. For example, the UE 302 may utilize a 2L TDD uplink configuration such that the UE 302 uses one TDD carrier for one layer (e.g., one data stream) and another TDD carrier for a second layer (e.g., a second data stream) to communicate with the network node 310. In another example, the UE 302 may utilize 1L TDD + 1L FDD UL CA for uplink such that the UE uses one TDD carrier for one layer (e.g., one data stream) and one FDD carrier for a second layer (e.g., a second data stream). In yet another example, the UE 302 may utilize 1L TDD for uplink such that the UE 302 uses one TDD carrier for a single layer (e.g., only one data stream).

At a second step 322, the network node 310 performs logic to determine an uplink configuration for subsequent communications from the UE 302 to the network node 310. The time at which the second step 322 occurs comprises a first time. The first time may be a time of day, a day of the week, a week of the month, a month of a year, and the like, including any combination thereof. The network node 310 may access real time data associated with the first time and/or historical data to perform the logic of the second step 322. The real time data and/or historical data may be stored locally at the network node 310 and/or may be accessed by the network node 310 via the network 308. In some aspects, the logic of the second step 322 occurs at regular intervals such that the network node 310 regularly determines whether to instruct the UE 302 to utilize a different uplink configuration, such as to increase the performance of the UE 302. In aspects, the regular intervals may be every 30 seconds, every minute, every 5 minutes, and the like.

In other aspects, the logic of the second step 322 may be triggered by one or more triggers. The one or more triggers may include the performance of the UE 302 being suboptimal, the location of the UE 302 changing, and/or an increase in network traffic. In aspects, the logic of the second step 322 is triggered based on a determination by the network node 310 that a performance of the UE 302 is suboptimal, such as by a performance indicator falling below a pre-determined threshold. In aspects, the performance indicator may be a reference signal received power (RSRP) value, a signal to noise interference ratio (SINR) value, a received signal strength indicator (RSSI) value, a reference signal received quality (RSRQ) value, channel quality indicator (CQI) value, and the like. In aspects, the network traffic within the network 308 may change such that an indicator of the network load (e.g., throughput, latency, packet loss) indicates the network is congested (e.g., indicator exceeds a threshold) and/or is experiencing high interference (e.g., indicator exceeds a threshold) and triggers the logic of the second step 332. In aspects, the location of the UE 302 may change such that the UE 302 exits a threshold distance of the cell edge and/or enters the threshold distance of the cell edge, which triggers the logic of the second step 322. For example, the threshold distance of a cell edge may comprise a border of a near cell (e.g., the near cell 220 of FIG. 2) and extend away from the near cell, away from the network node 310, into a far cell (e.g., the far cell 222 of FIG. 2), and extending to the cell edge of the network node 310.

The real time data utilized by the network node 310 at the second step 322 may include performance of the UE 302, network traffic information, location information associated with the UE 302, and/or a time in which the second step occurs 322 (i.e., the first time). The real time data may include the performance of the UE 302 at the first time (e.g., RSRP, SINR, RSSI, RSRQ). The real time data may include an indication of the network load of the network 308 generally (e.g., throughput, latency, packet loss) at the first time. For example, the indicator of the network load may indicate the network is congested. The real time data may include location information of the UE 302 at the first time. The location information may comprise timing advance (TA), round trip time (RTT), angle of arrival (AoA), time difference of arrival (TDOA), and the like. In aspects, the location information comprises a determination that the UE 302 is within the threshold distance of a cell edge of the network node 310. In aspects, when the UE 302 is within the threshold distance of the cell edge, the UE 302 may, in some aspects based on the real time data and/or the historical data, have improved performance when utilize a 1L TDD + 1L FDD UL CA uplink configuration over a 2L TDD uplink configuration or a 1L TDD uplink configuration.

The historical data utilized by the network node 310 at the second step 322 may include an uplink utilization pattern of the UE 302 during a time period. For example, the UE 302 may have low uplink demand from the hours of 5PM to 9PM within a singular day, and may have high uplink demand from the hours of 9AM to 12PM within the singular day. This pattern may vary depending on the day of the week. The historical data may include historical location data of the UE 302, such as a most frequent location of the UE 302 (e.g., the location in which the UE 302 is present the longest during a given time period). In aspects, the historical data may include the network’s 308 utilization pattern during a time period. For example, the network 308 may be under-utilized from 12AM to 5AM during a Saturday 24 hour period, which may impact the determination at the second step 322. The historical data may include performance history data of the UE 302. In aspects, the network node 310 may log performance indicators of the UE 302, the UE’s 302 location relative to the network node 310 (e.g., near cell, border of near cell and far cell, far cell), the UE’s 302 particular uplink configuration (e.g., 2L TDD, 1L TDD + 1L FDD UL CA, 1L TDD), the UE’s 302 uplink demand, and/or one or more indicators of network load collected at one or more times prior to the first time by the network node 310.

In aspects, the UE 302 may be associated with a group of UEs, which may be one group of a plurality of groups of UEs. The group of UEs may be grouped based on any one or more similarities shared among each UE within the group. In some aspects, the group of UEs are subscribed to the same network slice such that the network node 310 only performs the logic of the second step 322 for UEs subscribed to a particular network slice. In other aspects, the group of UEs is an international mobile equipment identity (IMEI) group, internet protocol (IP) address group, media access control (MAC) address group, subscriber identifier group, and the like). In aspects, the group of UEs may be grouped based on their compatibility with a 2L TDD uplink configuration and/or 1L TDD + 1L FDD UL CA uplink configuration. The group of UEs may be grouped based on their most frequent locations (e.g., a location in which the UE 302 is present the longest during a given time period, such as a month) being within the threshold distance of the cell edge of the network node 310. In some aspects, the UE 302 is a FWA device, such as a router within a residential home, and may be associated with a stationary location within the threshold distance of the cell edge of the network node 310. In such aspects, the FWA device may be part of a group of FWA devices located within the threshold distance of the cell edge of the network node 310. In aspects, the group of UEs may be prioritized for the methods described herein such that only UEs within one or more group of UEs may receive the methods described herein.

In some aspects, at the second step 322, the network node 310 utilizes artificial intelligence and/or machine learning principles to predict the performance of the UE 302 under different uplink configurations and/or weigh the uplink demand of the UE 302 with the network load of the network 308, based on the real time data at the first time and the historical data. In aspects, the network node 310 uses the performance history logs of the UE 302 to determine that, based on the real time data of the UE 302 at the first time, the UE 302 is predicted to have improved performance (e.g., relative to the performance of the UE 302 at the first time) utilizing one particular uplink configuration over one or more others. For example, when the UE 302 is within the threshold distance of the cell edge of the network node 310, the network node 310 may determine the UE 302 has historically improved performance in such locations and/or at such times during the first time in the past when utilizing a 1L TDD + 1L FDD UL CA uplink configuration. In this example, at the second step 322, the network node 310 may determine to instruct the UE 302 to utilize the predicted 1L TDD + 1L FDD UL CA uplink configuration.

In another example, the historical data may indicate the UE 302 is a stationary FWA device that is located at a stationary location near the cell edge and the historical data may indicate the FWA device historically has lower uplink demand from the hours of 9PM-5AM. The real time data may indicate the first time is 10PM, and that an indicator of the network load of the network 308 is congested at the first time. In aspects, the network node may predict the performance of the UE 302 will not be severely impacted by utilizing a lower bandwidth uplink configuration (e.g., where there is a reduced predicted uplink demand), and may determine to instruct the UE 302 to utilize the lower bandwidth uplink configuration due to the network being congested, resulting in an effective balance of network resource utilization with performance of the UE 302.

At the third step 324, the network node 310 instructs the UE 302 to utilize the uplink configuration determined by the network node 310 at the second step 322, and the UE 302 receives the instructions to utilize the first uplink configuration determined at the second step 322. In some aspects, the uplink configuration determined at the second step 322 is the same as the uplink configuration the UE 302 utilized to send the communication of the first step 320. For example, after consideration, the network node 310 may determine the existing uplink configuration is predicted to provide the highest performance relative to other uplink configurations. In other aspects, the uplink configuration determined at the second step 322 is different than the uplink configuration the UE 302 utilized to send the communication of the first step 320.

In aspects, based on the determination of the second step 322 and the instructing at the third step 325, the network node 310 may determine to modify a beamforming method of one or more beams associated with the UE 302. For example, where a 2L TDD uplink configuration is determined, the network node 310 may modify the beamforming method from a first beamforming method associated with a first uplink configuration (e.g., 1L TDD + 1L FDD UL CA, 1L TDD) to a second beamforming method associated with the 2L TDD uplink configuration. In this example, the first beamforming method may comprise a sounding reference signal (SRS) beamforming method, and the second beamforming method is a codebook beamforming method.

At the fourth step 326, the UE 302 communicates with the network node 310 utilizing the uplink configuration determined in the second step 322. At the fifth step 328, the network node 310 communicates with the network 308 to enable access to data and/or services to the UE 302. At the sixth step 330, the UE 302 accesses the data and/or services from the network 308 via the network node 310.

In aspects, at a second time occurring subsequent to the first time, the network node 310 may re-determine, based on real time data associated with the second time and/or historical data, to instruct the UE 302 to cease utilizing the first uplink configuration. In such aspects, the network node 310 may instruct the UE 302 to utilize a second uplink configuration based on the re-determination. In some aspects, such a determination may be based on a predicted performance of the UE 302 being higher when the UE 302 utilizes the second uplink configuration. In aspects, the re-determination is one of a regular interval of re-determinations and/or is triggered by one or more triggers described with respect to the second step 322.

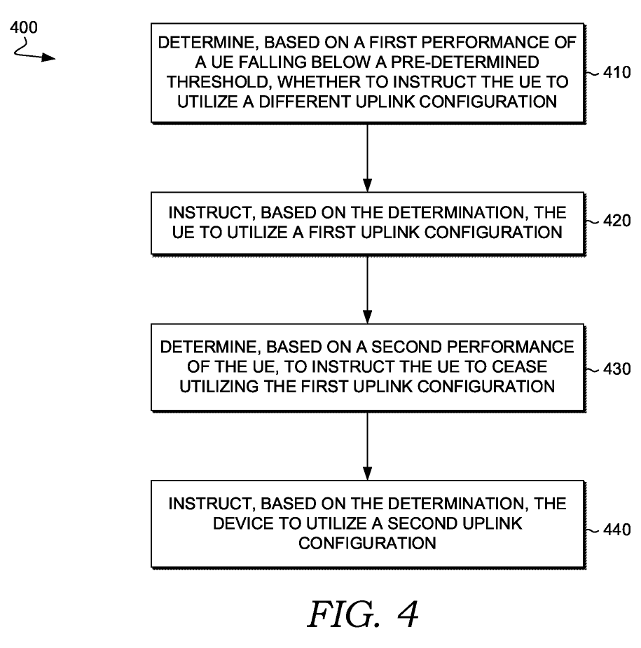

Now referring to FIG. 4, a flow chart is provided that illustrates one or more aspects of the present disclosure relating to a method 400 for dynamically utilizing one or more TDD and/or FDD carriers during uplink. The method 400 may include any one or more aspects described with respect to FIGS. 2-3.

At a first step 410, the method 400 includes determining, by a network node (e.g., the base station 210 of FIG. 2, the network node 310 of FIG. 3), based on a first performance of a user equipment (UE) (e.g., the first UE 202, the second UE 204, the third UE 206 of FIG. 2, the UE 302 of FIG. 3), falling below a pre-determined threshold, whether to instruct the UE to utilize a different uplink configuration. In aspects, the first performance is a RSRP value and/or a SINR value. In aspects, the network node may consider real time data associated with a first time and/or historical data when determining whether to instruct the UE to utilize a different uplink configuration, as described with respect to FIG. 3. In aspects, the network node determines to instruct the UE to utilize a different uplink configuration.

As one example, the UE may be a mobile device that is traveling around a coverage area of the network node and may be utilizing an uplink configuration (e.g., 2L TDD). At a cell edge, the performance of the UE may fall below a threshold and trigger the determination by the network node. The network node may further consider the historical demands of the UE when the UE has historically been located at or near the real time location of the UE. For example, the UE may historically have high uplink demand at this location and/or at the first time. Based on these considerations, the network node may determine the UE to instruct the UE to utilize a different uplink configuration (e.g., 1L TDD, 1L TDD + 1L FDD UL CA).

At a second step 420, the method 400 includes instructing, based on the determination, the UE to utilize a first uplink configuration. The first uplink configuration may be a 1L TDD uplink configuration, a 2L TDD uplink configuration, or a 1L TDD + 1L FDD UL CA, as described above with respect to FIG. 3.

At a third step 430, the method 400 includes determining, by the network node and based on a second performance of the UE, to instruct the UE to cease utilizing the first uplink configuration. In aspects, the second performance may be a lower quality than the first performance and/or may fall below a pre-determined threshold, which may trigger the network node to determine whether to instruct the UE to cease using the first uplink configuration in favor of a different uplink configuration.

In the example described with respect to the first step 410, the UE may have moved to a location at a border of a near cell (e.g., the near cell 220 of FIG. 2) and a far cell (e.g., the far cell 222 of FIG. 2). At this location and at the first time historically, the UE has low uplink demand. Further, an indicator of the network load indicates the network is congested. In this example, the network node may, based on these considerations, determine to instruct the UE to cease using the first uplink configuration in favor of a different uplink configuration.

At a fourth step 440, the method 400 includes instructing, based on the determining of the third step 430, the UE to utilize a second uplink configuration different from the first uplink configuration.

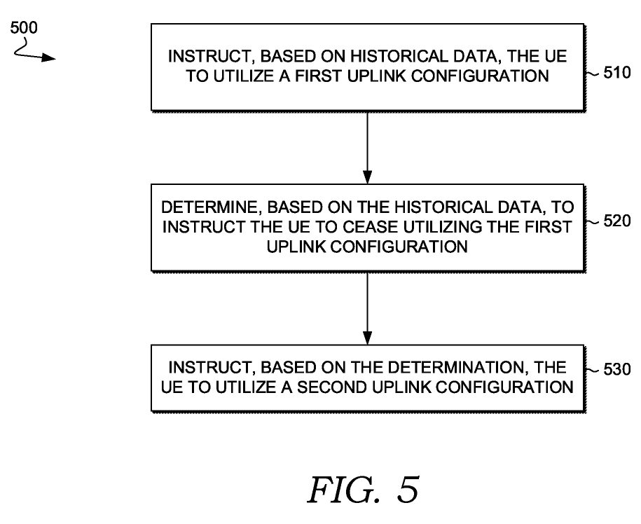

Now referring to FIG. 5, a flow chart is provided that illustrates one or more aspects of the present disclosure relating to a method 500 for dynamically utilizing one or more TDD and/or FDD carriers during uplink. The method 500 may include any one or more aspects described with respect to FIGS. 2-4.

At a first step 510, the method 500 includes instructing, by a network node (e.g., the base station 210 of FIG. 2, the network node 310 of FIG. 3), based on historical data, the UE to utilize a first uplink configuration. In aspects, the first uplink configuration may be a 1L TDD uplink configuration, a 2L TDD uplink configuration, or a 1L TDD + 1L FDD UL CA uplink configuration, as described above with respect to FIG. 3. In aspects, the UE is a part of a group of UEs (e.g., subscribed to the same network slice, grouped together via IMEIs) compatible with the first uplink configuration, and each UE of the group of UEs are within a threshold distance of a cell edge of the network node. In such aspects, the UE may be instructed to utilize a 1L TDD uplink configuration or a 1L TDD + 1L FDD UL CA uplink configuration based on the real time data indicating the UE is within a threshold distance of the cell edge and based on the historical data of the UE indicating the first uplink configuration provides increased performance over other uplink configurations when the UE has been historically within the threshold distance of the cell edge.

At the second step 520, the method 500 includes determining, based on the historical data, to instruct the UE to cease utilizing the first uplink configuration. In aspects, the historical data comprises an uplink utilization pattern of the UE during a time period, a performance history of the UE when utilizing the first uplink configuration and a performance history of the UE when utilizing a second uplink configuration, and/or a network utilization patterns during a time period. For example, an uplink utilization pattern of the UE may indicate the UE needs less uplink capacity from the hours of 12AM – 4AM, and the network node may determine to instruct the UE to cease utilizing the first uplink configuration in favor of a different uplink configuration. In another example, a historical performance of the UE using the first uplink configuration may be reduced relative to a historical performance of the UE using the second uplink configuration at the particular time of day in which the determining occurs (e.g., 2PM on a Saturday).

At a third step 530, the method 500 includes instructing, based on the determination, the UE to utilize the second uplink configuration, as described with respect to FIGS. 2-4. In some aspects, such as when the UE is located within a threshold distance from the cell edge, the first uplink configuration is a 1L TDD + 1L FDD UL CA uplink configuration and the second uplink configuration is a 1L TDD uplink configuration.

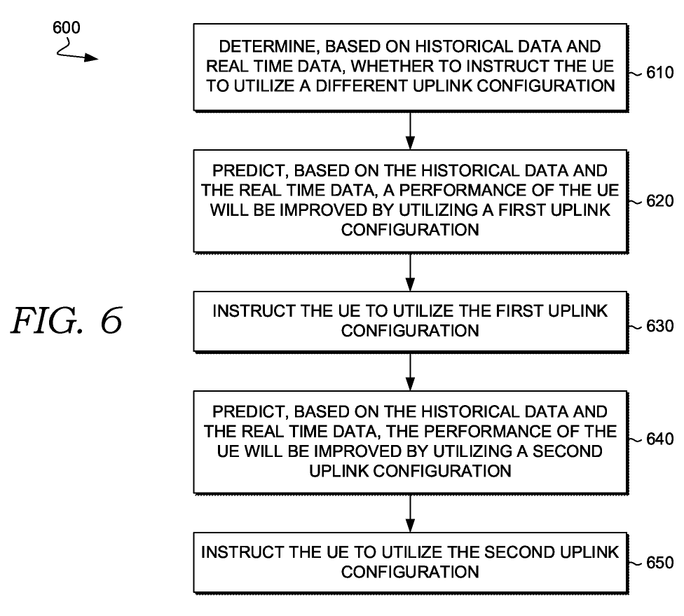

Now referring to FIG. 6, a flow chart is provided that illustrates one or more aspects of the present disclosure relating to a method 600 for dynamically utilizing one or more TDD and/or FDD carriers during uplink. The method 600 may include any one or more aspects described with respect to FIGS. 2-5.

At a first step 610, the method 600 includes determining, based on historical data and real time data, whether to instruct a UE to utilize a different uplink configuration, as described with respect to FIGS. 2-5. In aspects, the determining may be triggered by one or more triggers or the determining may occur at regular intervals. In aspects, the real time data indicates the UE is within a threshold distance of the cell edge of the network node, as described with respect to FIG. 3. In some aspects, the real time data indicates the UE is at the cell edge, is within a far cell (e.g., the far cell 222 of FIG. 2), and/or is at a border of a near cell (e.g., the near cell 220 of FIG. 2) and the far cell.

At a second step 620, the method 600 includes predicting, by a network node and based on the historical data and the real time data, a performance of the UE will be improved by utilizing a first uplink configuration. The second step 620 may occur at a first time. As one example, the historical data may indicate the UE has increased uplink demand from the hours of 3PM to 6PM, and the real time data may indicate the first time is at 4PM. In this example, the network node may determine the predicted performance of the UE will be improved by utilizing a 1L TDD + 1L FDD UL CA uplink configuration, as this uplink configuration typically increases the overall bandwidth available for uplink by the UE.

In another example, the real time data may indicate the UE is located at the cell edge, and the historical data indicates the historical performance of the UE, when at the cell edge, is improved when the UE utilizes a 1L TDD uplink configuration. In yet another example, the real time data may indicate the UE is located at the far cell, and the historical data indicates the historical performance of the UE, when at the far cell, is improved when the UE utilizes a 1L TDD + 1L FDD UL CA uplink configuration. In yet another example, the real time data may indicate the UE is located at the border of the near cell and the far cell and that the first time is at 1PM. In this example, the historical data may indicate the UE has increased uplink demand between 12PM-5PM, and as a result, the network node predicts the UE will have improved performance when the UE utilizes a 1L TDD + 1L FDD UL CA uplink configuration. In this example, if the historical data indicates the UE has decreased uplink demand between 12PM-5PM, the network node may predict the UE will have improved performance when the UE utilizes a 1L TDD uplink configuration.

At a third step 630, the network node instructs the UE to utilize the first uplink configuration. In aspects, the first uplink configuration may be a 1L TDD + 1L FDD UL CA uplink configuration, a 2L TDD uplink configuration, or a 1L TDD uplink configuration.

At a fourth step 640, the network node determines, based on the historical data and the real time data, the performance of the UE will be improved by utilizing a second uplink configuration. The fourth step 640 occurs at as second time occurring after the first time. In aspects, the real time data at the first time (e.g., at the second step 620) is different than the real time data at the second time (e.g., at the fourth step 640). For example, the real time data at the first time may indicate the UE is at the cell edge, and the real time data at the second time may indicate the UE is at the border of the near cell and the far cell. In this example, the second uplink configuration would improve the performance of the UE given the change in location. In another example, the real time data at the first time indicates the UE has a high uplink demand, and the real time data of the second time indicates the UE has a low uplink demand. In this example, the second uplink configuration would improve the performance of the UE given the reduction in uplink demand.

At a fifth step 650, the network node instructs the UE to utilize the second uplink configuration. In aspects, the first uplink configuration may be a 1L TDD + 1L FDD UL CA uplink configuration, a 2L TDD uplink configuration, or a 1L TDD uplink configuration.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

We claim:

1. A system for dynamically utilizing one or more time duplex division (TDD) and frequency duplex division (FDD carriers) for uplink, the system comprising:
one or more computer processing components configured to perform operations comprising:
determining, based on a first performance of a user equipment (UE) falling below a pre-determined threshold, whether to instruct the UE to utilize a different uplink configuration;
instructing, based on the determining, the UE to utilize a first uplink configuration comprising utilizing a TDD carrier for a first layer and utilizing a FDD carrier for a second layer;
determining, based on a second performance of the UE, to instruct the UE to cease utilizing the first uplink configuration; and
instructing, based on the determining, the UE to utilize a second uplink configuration comprising utilizing one or more TDD carriers for one or more of the first layer and the second layer.

2. The system of claim 1, wherein the first performance and the second performance of the UE comprise a received signal received power (RSRP) value.

3. The system of claim 1, wherein the first performance and the second performance of the UE comprise a signal interference to noise ratio (SINR).

4. The system of claim 1, wherein the determining whether to instruct the UE to utilize the different uplink configuration is further based on the UE being within a threshold distance of a cell edge of a network node.

5. The system of claim 1, further comprising modifying, based on the second uplink configuration, a beamforming method of one or more beams associated with the UE.

6. The system of claim 1, wherein the UE is a part of a group of UEs compatible with utilizing the first uplink configuration.

7. The system of claim 6, wherein each UE of the group of UEs is assigned to a particular network slice.

8. A method for dynamically utilizing one or more time division duplex (TDD) and frequency division duplex (FDD) carriers for uplink, the method comprising:
instructing, by a network node, based on historical data, the UE to utilize a first uplink configuration comprising utilizing TDD carrier for a first layer and utilizing a frequency division duplex FDD carrier for a second layer, wherein the UE is part of a group of UEs compatible with the first uplink configuration, and wherein each UE of the group of UEs are within a threshold distance of a cell edge of the network node;
determining, based on the historical data, to instruct the UE to cease utilizing the first uplink configuration; and
instructing, based on the determination, the UE to utilize a second uplink configuration comprising utilizing one or more TDD carriers for one or more of the first layer and the second layer.

9. The method of claim 8, wherein each UE of the group of UEs is subscribed to a particular network slice.

10. The method of claim 9, wherein the group of UEs is an international mobile equipment identity (IMEI) group.

11. The method of claim 8, wherein the historical data comprises an uplink utilization pattern of the UE during a time period.

12. The method of claim 8, wherein the historical data comprises a historical performance of the UE when utilizing the first uplink configuration and a historical performance of the UE when utilizing the second uplink configuration.

13. The method of claim 8, wherein the historical data comprises network utilization during a time period.

14. The method of claim 8, further comprising modifying, based on the second uplink configuration, a beamforming method of one or more beams associated with the UE.

15. A method for dynamically utilizing one or more time division duplex (TDD) and frequency division duplex (FDD) carriers for uplink, the method comprising:
determining, by a network node, based on historical data and real time data associated with a first time, whether to instruct a user equipment (UE) to utilize a different uplink configuration, wherein the real time data indicates the UE is within a threshold distance of a cell edge of the network node;
predicting, based on the historical data and the real time data associated with the first time, a performance of the UE will be improved by utilizing a first uplink configuration comprising utilizing a TDD carrier for a first layer and utilizing FDD carrier for a second layer;
instructing the UE to utilize the first uplink configuration;
predicting, based on the historical data and the real time data associated with a second time subsequent to the first time, the performance of the UE will be improved by utilizing a second uplink configuration comprising utilizing TDD carriers for the first layer and for the second layer; and
instructing the UE to utilize the second uplink configuration.

16. The method of claim 15, wherein the UE is a part of a group of UEs compatible with the first uplink configuration.

17. The method of claim 16, wherein the UE is a fixed wireless access (FWA) device, and wherein each UE of the group of UEs is an FWA device.

18. The method of claim 15, wherein the threshold distance from the cell edge comprises a border of a near cell and a far cell of the network node and extends to the cell edge.

19. The method of claim 15, wherein the real time data associated with the second time indicates the UE is located outside of the threshold distance from the cell edge.

20. The method of claim 13, wherein the UE is located at a stationary location within the threshold distance of the cell edge, wherein the historical data comprises a historical performance of the UE when utilizing the first uplink configuration, and wherein the historical data comprises a historical performance of the UE when utilizing the second uplink configuration.
